(19) United States
(12) Patent Application Publication
(10) Pub. No.: US 2023/0111441 A1
(43) Pub. Date: Apr. 13, 2023

(54) LiDAR DEVICE

(71) Applicant: SAMSUNG ELECTRONICS CO., LTD., Suwon-si (KR)

(72) Inventors: Changgyun SHIN, Anyang-si (KR); Hyunil BYUN, Seongnam-si (KR); Dongjae SHIN, Seoul (KR); Changbum LEE, Seoul (KR)

(73) Assignee: SAMSUNG ELECTRONICS CO., LTD., Suwon-si (KR)

(21) Appl. No.: 17/682,888

(22) Filed: Feb. 28, 2022

(30) Foreign Application Priority Data
Oct. 8, 2021 (KR) 10-2021-0134450

(51) Int. Cl. G01S 7/481

(52) U.S. Cl. CPC G01S 7/4817; G01S 7/4813; G01S 7/4814

(57) ABSTRACT

Provided is a light detection and ranging (LiDAR) device including a housing including a window configured to transmit light, a light transmitter provided in the housing and configured to output light toward an object outside of the housing, an optical element provided adjacent to the window, first light from among the light being incident on the optical element, a light receiver provided in the housing and configured to receive, from among the light, second light reflected from the object, and a processor configured to change a steering direction of the light such that a ratio of the first light to the light is reduced.

### CROSS-REFERENCE TO RELATED APPLICATION

This application is based on and claims priority under 35 U.S.C. § 119 to Korean Patent Application No. 10-2021-0134450, filed on Oct. 8, 2021, in the Korean Intellectual Property Office, the disclosure of which is incorporated by reference herein in its entirety.

### BACKGROUND

### 1. Field

Example embodiments of the present disclosure relate to light detection and ranging (LiDAR) devices.

### 2. Description of Related Art

A light detection and ranging (LiDAR) device emits a laser beam and detects light reflected from a target object within a measurement range of the LiDAR device. In other words, the LiDAR device measures a distance to the object by using a time-of-flight (TOF) method. Accordingly, a LiDAR system may be used in various fields, for example, aerospace engineering, geology, three-dimensional (3D) mapping, automobiles, robots, drones, and the like. A LiDAR device of the related art steers a laser beam in order to output the laser beam in a field of view (FOV) range for measuring a distance. As a method of steering a laser beam, various methods such as mechanical rotation, change of diffraction, or change of a refraction condition of light may be used.

In the case of a device in which an emission angle of light is changed according to the change in a diffraction condition by a wavelength change, in order to generate light of a variable wavelength, the wavelength may be changed by varying a resonance oscillation condition of a laser by using a device such as a ring resonator. At this time, although an initial wavelength of a laser is precisely determined according to the physical conditions (in the case of a ring resonator, a circumference) of a resonator, in reality, it is difficult to have the physical conditions of manufactured resonators be exactly the same due to dispersion in a manufacturing process of the resonators or the like. An initial wavelength difference caused by dispersion in a manufacturing process may eventually cause a large dispersion during beam steering of a laser, and accordingly, it is necessary to correct the beam steering.

### SUMMARY

One or more example embodiments provide LiDAR devices configured to correct an initial wavelength difference of a laser due to dispersion in an actual manufacturing process and a resulting difference in a steering direction of light.

One or more example embodiments also provide LiDAR devices configured to correct a steering direction of light when there is an error after outputting the light as an initial setting value.

Additional aspects will be set forth in part in the description which follows and, in part, will be apparent from the description, or may be learned by practice of example embodiments.

According to an aspect of an example embodiment, there is provided a light detection and ranging (LiDAR) device including a housing including a window configured to transmit light, a light transmitter provided in the housing and configured to output light toward an object outside of the housing, an optical element provided adjacent to the window and on which first light from among the light transmitted by the light transmitter is incident, a light receiver provided in the housing and configured to receive second light reflected from the object, from among the light transmitted by the light transmitter, and a processor configured to change a steering direction of the light such that a ratio of the first light to the light transmitted by the light transmitter is reduced.

The light transmitter may include a light source, and a beam steering element configured to steer the light output from the light source toward the object.

The beam steering element may include an optical phase array configured to steer the light to change a steering direction of the light based on a wavelength of the light.

The light transmitter may further include a resonator provided at both ends of the light source and configured to change a wavelength of the light.

The resonator may include a first ring resonator having a first circumference and a second ring resonator having a second circumference that is less than the first circumference, and wherein the first ring resonator is configured to, based on a driving signal applied to the first ring resonator, increase the wavelength of the light, and the second ring resonator is configured to, based on a driving signal applied to the second ring resonator, decrease the wavelength of the light.

The processor may be further configured to, based on the first light being detected by the optical element or the light receiver, apply a driving signal to one of the first ring resonator and the second ring resonator to change the steering direction of the light.

The optical element may include at least one reflector configured to reflect the first light toward the light receiver, and wherein the light receiver may be configured to receive the first light.

The at least one reflector may include at least one of a flat mirror and a diffuse reflector.

A partial surface of the at least one reflector may be inclined at a predetermined angle with respect to the housing such that the first light that is incident is reflected toward the light receiver.

The optical element may include at least one photodetector configured to detect the first light that is incident.

An area of the window may be greater than or equal to an area of the housing which is irradiated by the light steered by the light transmitter.

The optical element may include a first optical element provided above the window and a second optical element provided below the window.

According to another aspect of an example embodiment, there is provided a light detection and ranging (LiDAR) device including a housing including a window configured to transmit light, a light transmitter provided in the housing and configured to output light toward an object outside of the housing, a light receiver provided in the housing and including a light detection array, the light detection array including a first region configured to detect first light reflected or scattered from the housing among the light transmitted by the light transmitter, and a second region configured to detect second light reflected from the object among the light transmitted by the light transmitter, and a processor configured to change a steering direction of the light such that a ratio of the first light to the light transmitted by the light transmitter is reduced.

The light detection array may include a plurality of detection elements, and the first region and the second region may not overlap each other.

The light transmitter may include a light source, a beam steering element configured to steer the light output from the light source, and a resonator provided at both ends of the light source and configured to change a wavelength of the light.

The beam steering element may include an optical phase array configured to steer the light to change the steering direction of the light based on the wavelength of the light.

The resonator may include a first ring resonator having a first circumference and a second ring resonator having a second circumference that is less than the first circumference, and wherein the first ring resonator is configured to, based on a driving signal applied to the first ring resonator, increase the wavelength of the light, and wherein the second ring resonator is configured to, based on a driving signal applied to the second ring resonator, decrease the wavelength of the light.

The processor may be further configured to apply a driving signal to the resonator based on the first light being detected in the first region.

The second region may be at least partially adjacent to the first region.

The LiDAR device may further include an optical element provided adjacent to the window, wherein the first light from among the light is incident on the optical element.

### BRIEF DESCRIPTION OF THE DRAWINGS

The above and/or other aspects, features, and advantages of example embodiments will be more apparent from the following description taken in conjunction with the accompanying drawings, in which:

FIG. 1A is a diagram illustrating a LiDAR device including a flat mirror as an optical element according to an example embodiment;

FIG. 1B is a block diagram illustrating signal processing performed by the LiDAR device according to an example embodiment;

FIG. 10 is a diagram illustrating a resonator of the LiDAR device according to an example embodiment;

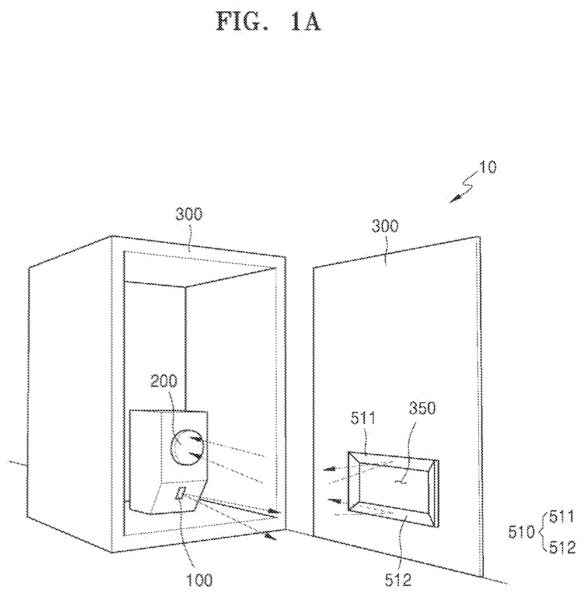

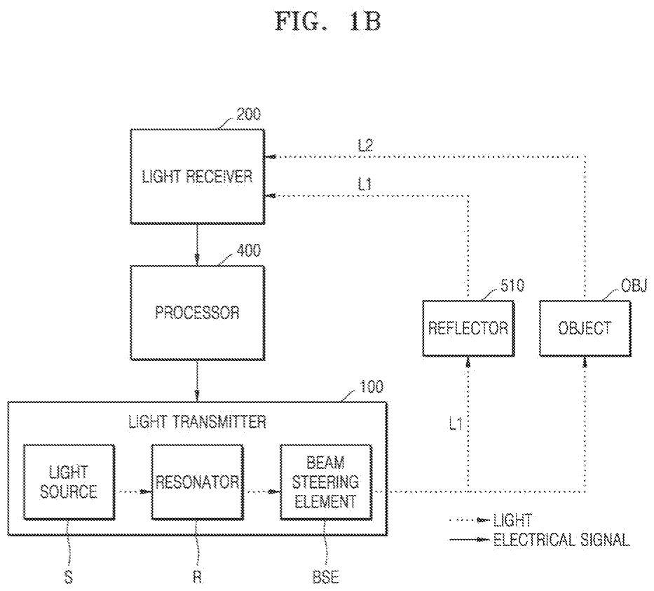

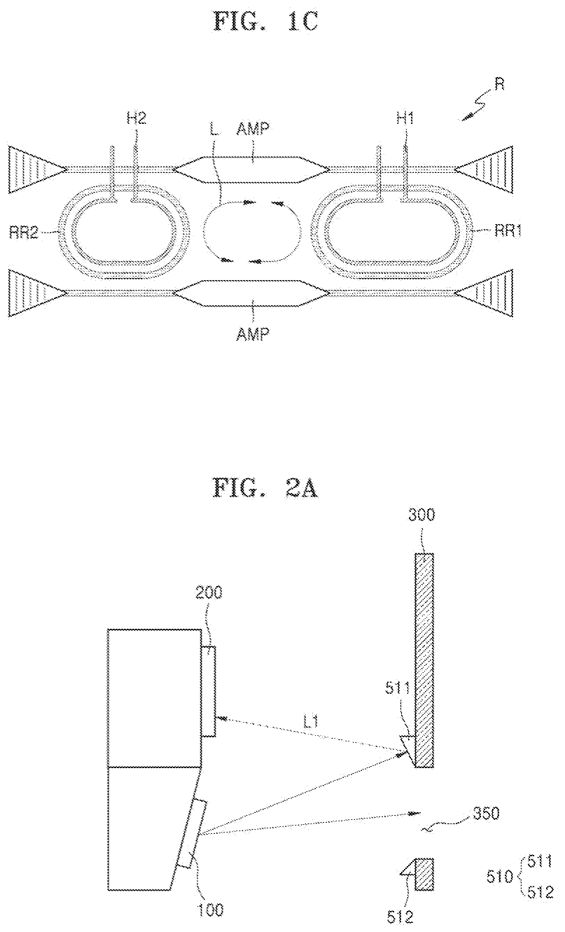

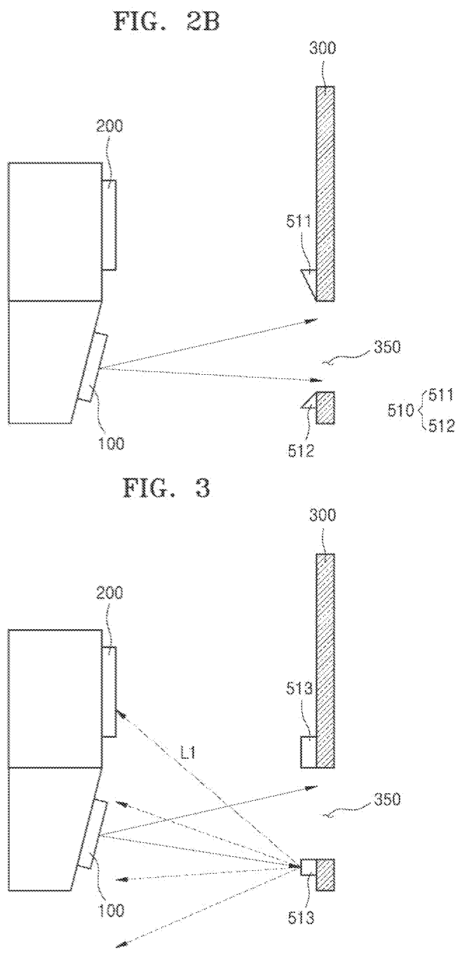

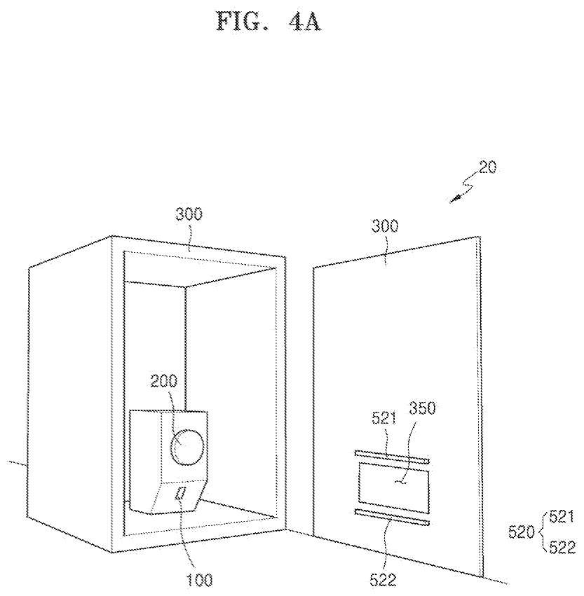

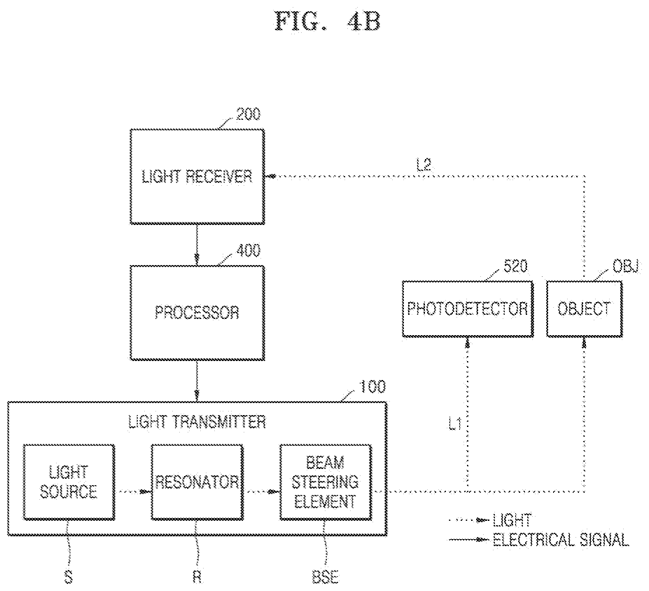

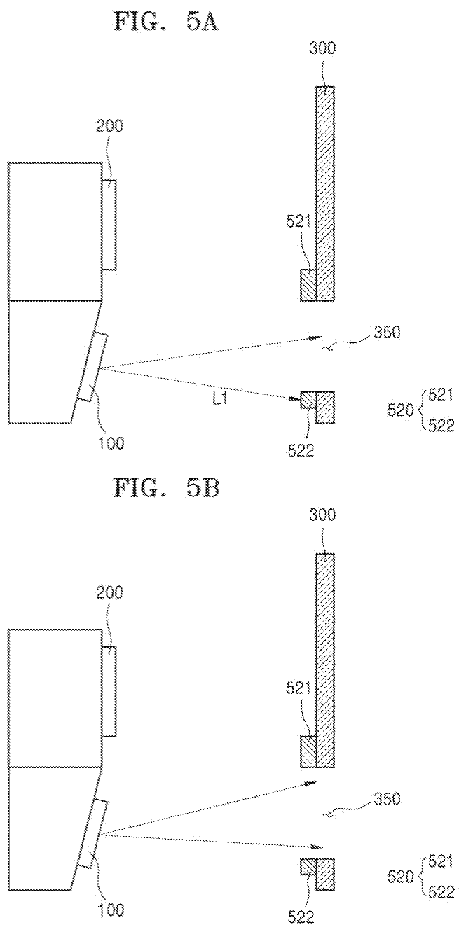

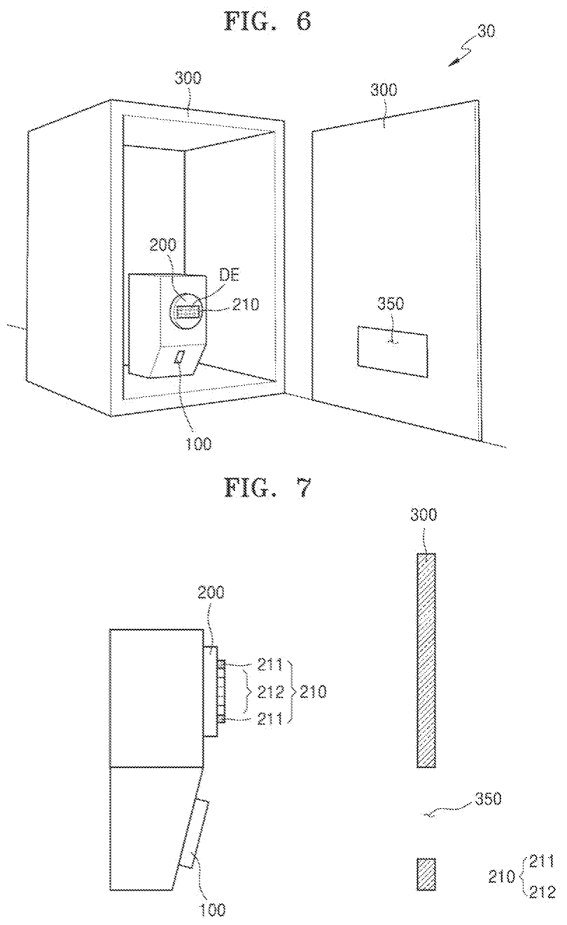

FIG. 2A is a cross-sectional view of the LiDAR device of FIG. 1A;

FIG. 2B is a cross-sectional view of the LiDAR device showing a direction of light after beam steering correction;

FIG. 3 is a cross-sectional view illustrating a LiDAR device including a diffuse reflector as an optical element according to an example embodiment;

FIG. 4A is a diagram illustrating a LiDAR device including a photodetector as an optical element according to an example embodiment;

FIG. 4B is a block diagram illustrating signal processing performed by the LiDAR device according to an example embodiment;

FIG. 5A is a cross-sectional view of the LiDAR device of FIG. 4A;

FIG. 5B is a cross-sectional view of the LiDAR device showing a direction of light after beam steering correction;

FIG. 6 is a conceptual diagram of a LiDAR device according to an example embodiment;

FIG. 7 is a cross-sectional view of the LiDAR device of FIG. 6;

FIG. 8 is a flowchart of a beam steering correction method according to an example embodiment;

FIG. 9 is a block diagram illustrating a configuration of an electronic device including a LiDAR device according to an example embodiment;

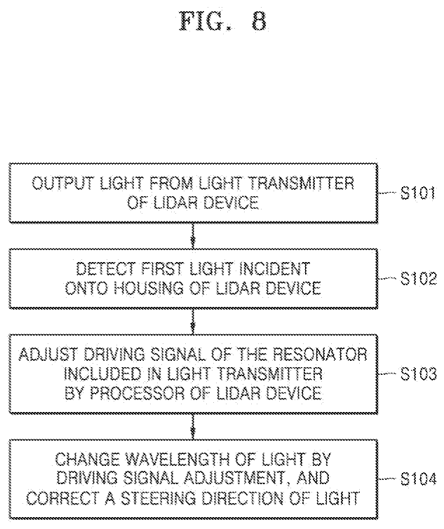

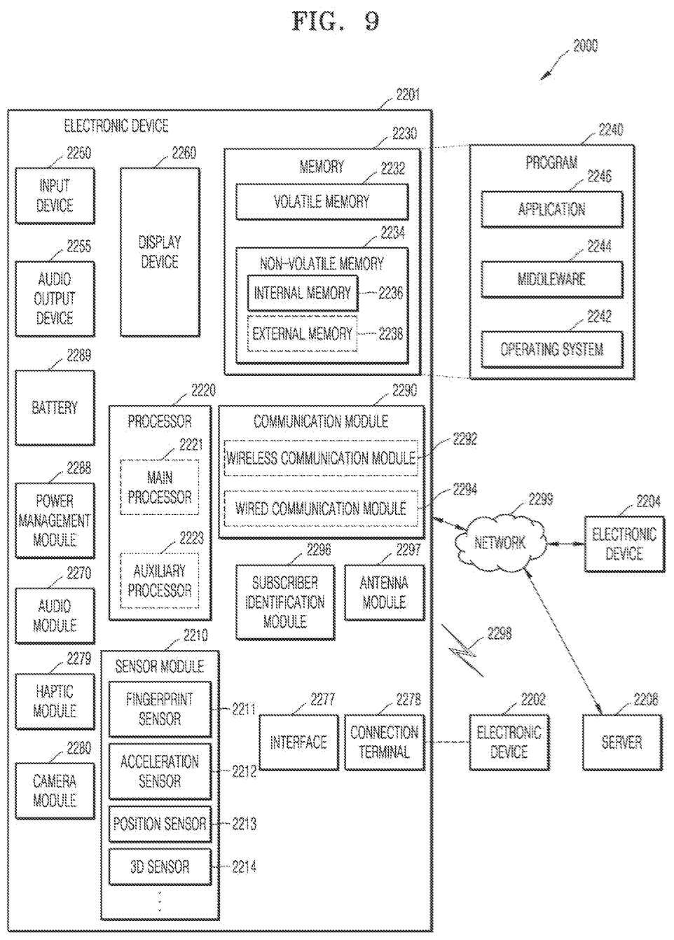

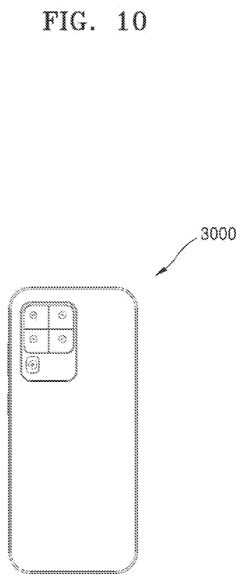

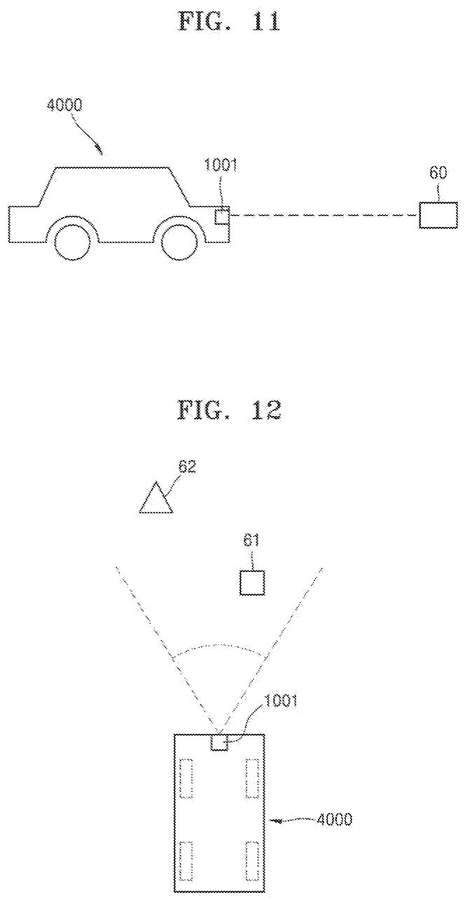

FIG. 10 is a perspective view illustrating an electronic device to which a LiDAR device according to an example embodiment is applied; and

FIGS. 11 and 12 are respectively a side view and a plan view of a vehicle including a LiDAR device.

### DETAILED DESCRIPTION

Reference will now be made in detail to embodiments, examples of which are illustrated in the accompanying drawings, wherein like reference numerals refer to like elements throughout. In this regard, the example embodiments may have different forms and should not be construed as being limited to the descriptions set forth herein. Accordingly, the example embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

Hereafter, example embodiments will be described more fully with reference to the accompanying drawings. The example embodiments may be variously modified and may be embodied in many different forms. In the drawings, like reference numerals refer to like elements, and the size of each component may be exaggerated for clarity and convenience of explanation.

When an element or layer is referred to as being “on” or “above” another element or layer, the element or layer may be directly on another element or layer or intervening elements or layers. Likewise, when an element or layer is referred to as being “below” or “under” another element or layer, the element or layer may be directly below another element or layer or intervening elements or layers.

In the following descriptions, the singular forms include the plural forms unless the context clearly indicates otherwise. When a part “comprises” or “includes” an element in the specification, unless otherwise defined, it is not excluding other elements but may further include other elements.

The term “above” and similar directional terms may be applied to both singular and plural.

The meaning of “connection” may include not only a physical connection, but also an optical connection, an electrical connection, and the like.

The use of any and all examples, or exemplary language (e.g., “such as”) provided herein, is intended merely to better illuminate the inventive concept and does not pose a limitation on the scope of the inventive concept unless otherwise claimed.

Although the terms “first”, “second”, “third”, etc., may be used herein to describe various elements, these elements should not be limited by these terms. These terms are only used to distinguish one element from another.

The fact that a length unit, such as height, depth, and thickness are substantially the same or the same may include a difference within an error range recognized by those skilled in the art.

FIG. 1A is a diagram illustrating a LiDAR device 10 including a flat mirror as an optical element, FIG. 1B is a block diagram illustrating signal processing performed by the LiDAR device 10 according to an example embodiment, and FIG. 10 is a diagram illustrating a resonator of the LiDAR device 10 according to an example embodiment. FIG. 2A is a cross-sectional view of the LiDAR device of FIG. 1A and FIG. 2B is a cross-sectional view of the LiDAR device showing a direction of light after beam steering correction. FIG. 3 is a cross-sectional view illustrating a LiDAR device including a diffuse reflector as an optical element according to an example embodiment.

The LiDAR device 10 according to an example embodiment may include a housing 300 including a window 350 having a light-transmitting property, a light transmitter 100 arranged in the housing 300 and configured to output light toward an object OBJ outside of the housing 300, an optical element arranged adjacent to the window 350 on the housing 300 and onto which first light L1 among light is incident, a light receiver 200 arranged in the housing 300 and configured to receive second light L2 reflected from the object OBJ among the light, and a processor 400 configured to adjust a steering direction of the light by using the first light so that a ratio of the first light to the light is reduced. The light transmitter 100 of the LiDAR device 10 according to an example embodiment may further include a light source S and a beam steering element BSE configured to steer light output from the light source S toward the object OBJ. The LiDAR device 10 according to the example embodiment may be configured to correct a steering direction of light, when the light is not emitted through the window 350 and incident on a portion of the housing 300 around the window 350, and the light may be incident on the optical element arranged on the housing 300. The optical element may be configured to directly detect light, or may be configured to reflect light incident on the optical element towards the light receiver 200. The optical element or the light receiver 200 may detect that some of the light output from the light transmitter 100 are not emitted through the window 350. Then, the processor 400 may apply a control signal for adjusting the steering direction of the light so that the ratio of the light that is not emitted through the window 350 is reduced.

The light transmitter 100 of the LiDAR device 10 according to an example embodiment may include a light source S and a beam steering element BSE configured to steer light output from the light source S. Light may be steered toward the object OBJ by the beam steering element BSE. The light source S may emit light having a predetermined wavelength or light having a predetermined wavelength band. The beam steering element BSE may steer light in a direction, for example, steer light in a vertical direction. For example, the beam steering element BSE may include an optical phase array (OPA). The optical phased array may steer light so that the steering direction is different according to a wavelength of light output from the light source S. In the present example embodiment, the beam steering element BSE that changes light in the vertical direction has been described, but the beam steering element BSE is not limited thereto and may be configured to change light in a horizontal direction. The light source S may be integrally formed with the beam steering element BSE.

The light transmitter 100 of the LiDAR device 10 according to an example embodiment may further include a resonator R arranged at both ends of the light source S and may vary a wavelength of light. The resonator R and the light source S may be used together to constitute a variable wavelength light source. The resonator R and the light source S may be integrally formed. The resonator R may include first ring resonator RR1 and a second ring resonator RR2. As shown in FIG. 10, the first ring resonator RR1 may have a first circumference and the second ring resonator RR2 may have a second circumference less than the first circumference. An optical amplifier AMP may be arranged between the first ring resonator RR1 and the second ring resonator RR2. The light source S and the optical amplifier AMP may be integrally formed. The optical amplifier AMP may be, for example, a semiconductor optical amplifier (SOA), and the SOA may serve as both the light source S and the optical amplifier AMP. A first heating element H1 and a second heating element H2 may be arranged along the circumferences of the first and second ring resonators RR1 and RR2. The first heating element H1 may be arranged on the first ring resonator RR1, and the second heating element H2 may be arranged on the second ring resonator RR2. By applying a signal, such as a voltage to the first ring resonator RR1 and the second ring resonator RR2, a resonance condition may be modulated to change a wavelength of light. For example, heat is applied to the first ring resonator RR1 and the second ring resonator RR2 through the first heating element H1 and the second heating element H2, respectively, thus, a resonance condition is changed and a wavelength of light may be changed. According to another example embodiment, a doping concentration may be changed by a change in current flowing through the first ring resonator RR1 and the second ring resonator RR2, and accordingly, a refractive index of resonator R is changed, and thus, a wavelength of light may be changed. However, embodiments are not limited thereto, and a wavelength of light may be changed by modulating a resonance condition by heat, voltage, etc. applied to the resonator R.

The first and second ring resonators RR1 and RR2 may vary a wavelength of light output from the light transmitter 100 by varying a reflection wavelength of a predetermined bandwidth of resonant light. The predetermined bandwidth of light may be changed by changing a driving voltage applied to the first ring resonator RR1 and/or the second ring resonator RR2. For example, the resonator R of the light transmitter 100 may be the first and second ring resonator RR1 and RR2 in FIG. 1C, but embodiments are not limited thereto. When a driving signal is applied to the first ring resonator RR1, a wavelength of light output from the optical transmitter 100 may increase, and when a driving signal is applied to the second ring resonator RR2, a wavelength of light output from the optical transmitter 100 may be reduced. When a wavelength of light is increased by applying a signal to the first ring resonator RR1, an angle at which a beam is steered may be reduced based on the normal to the beam steering element BSE. For example, when the wavelength of light is increased, the steered light may be closer to vertical. When a wavelength of light is reduced by applying a signal to the second ring resonator RR2, an angle at which a beam is steered may be increased based on a normal to the beam steering element BSE. For example, when the wavelength of light is reduced, the steered light may be closer to horizontal. When a wavelength of light is changed, the steering in the vertical direction may be changed by the beam steering element BSE, for example, an optical phased array.

The light receiver 200 of the LiDAR device 10 according to an example embodiment may detect light reflected by the object OBJ. Only a portion of the light output through the light transmitter 100 may be reflected from the object OBJ, and the reflected light may be incident on the light receiver 200. The light receiver 200 may include a plurality of detection elements DE (refer to FIG. 6), and the plurality of detection elements DE may constitute a light detection array 210 (refer to FIG. 6). Among the light output through the light transmitter 100, light reflected or scattered by the housing 300 may be incident on the light receiver 200.

The housing 300 of the LiDAR device 10 according to an example embodiment may be configured to surround the light transmitter 100 and the light receiver 200. For example, the housing 300 may have a rectangular parallelepiped or cube shape, and the light transmitter 100 and the light receiver 200 may be arranged inside the housing 300. However, the shape of the housing 300 is only an example, and is not limited thereto, and the housing 300 may have various shapes as long as it is configured to surround the light transmitter 100 and the light receiver 200. The housing 300 may include, on one side, a window 350 having a light transmittance through which light output from the light transmitter 100 exits to the outside of the housing 300. For example, the window 350 may be arranged on one side of the housing 300 facing the light transmitter 100, and the window 350 may have a rectangular cross section. The window 350 may be formed by removing a portion of the one side of the housing 300. In this case, the window 350 may denote an empty space. However, the cross-sectional shape of the window 350 or the method of forming the window 350 is not limited to the above example. For example, the window 350 may include a transparent material or a light-transmitting material.

Light output from the light transmitter 100 may be directed to the object OBJ located outside the housing 300 through the window 350, and light reflected by the object OBJ may enter an inside of the housing 300 through the window 350. However, embodiments are not limited thereto, and a part through which the reflected light enters may further be arranged. An area of the window 350 may be substantially equal to or greater than an area of a cross-section where an area covered by a field of view (FOV) of light and a surface on which the window 350 is arranged overlap each other. For example, the area of the window 350 may be substantially greater than or equal to an area through which light steered from the light transmitter 100 to have a constant field of view (FOV) is radiated to the housing 300. In this case, when the light is properly steered in the vertical direction, the light output from the light transmitter 100 may exit the housing 300 through the window 350 as a whole.

For example, an initial wavelength of light emitted from the light source S or the resonator R may be different from a predetermined wavelength due to manufacturing dispersion, and accordingly, the vertical steering direction of light may be different from a predetermined steering direction. In this case, only a portion of the light output from the light transmitter 100 may exit the housing 300 through the window 350, and the remaining portion may be incident on the housing 300. Among light, the light incident on the housing 300 may be referred to as a first light, and the light incident on and reflected from the object OBJ may be referred to as a second light. The LiDAR device 10 according to an example embodiment may include an optical element configured to detect the first light.

The optical element may be arranged adjacent to the window 350 on the housing 300, and the first light among the light output from the light transmitter 100 may be incident on the optical element. The optical element may be arranged around the window 350, for example, a portion of the housing 300 above the window 350, a portion of the housing 300 below the window 350, a portion of the housing 300 on a side of the window 350, etc. The optical element may have a configuration that may directly detect the first light, or a configuration that allows the first light to be detected by the light receiver 200.

The LiDAR device 10 according to an example embodiment may include a processor 400. The processor 400 may calculate a distance to an object OBJ interacted with the light by using a time of flight (TOF) method. The processor 400 of the LiDAR device 10 according to an example embodiment may calculate distances from the objects OBJ located within the field of view (FOV) of the LiDAR device 10, and may map the objects OBJ to a space covered by a viewing angle.

In addition, the processor 400 of the LiDAR device according to an example embodiment may adjust a steering direction of light so that a ratio of the first light to the light is reduced. For example, through an optical element arranged to detect the first light, the optical element may directly detect the first light, or the light receiver 200 may detect the first light. According to the detection of the first light, the processor 400 may apply a driving signal to the resonator R, and thus, an initial wavelength of light entering the beam steering element BSE may be changed by the resonator R to which the driving signal is applied. A vertical steering angle of the light steered by the beam steering element BSE may be changed by the changed wavelength of the light. An angular direction to be changed may be a direction in which a ratio of the first light is reduced. The magnitude of a driving signal may be changed according to the detected intensity of the first light. When a ratio of the first light to the output light is equal to or less than a certain ratio or is almost 0, the processor 400 may stop adjusting the light steering direction. According to another example embodiment, when the intensity of the first light is equal to or less than a certain intensity or is almost 0, the processor 400 may stop adjusting the light steering direction.

In the processor 400, the first light and the second light may be distinguished. When the optical element is a photodetector 520 which will be described later with reference to FIGS. 4A to 5B, the light detected by the photodetector 520 may be the first light, and the light detected by the light receiver 200 may be the second light. When the optical element is a reflector 510 which reflects the first light toward the light receiver 200, the first light among the light incident to the light receiver 200 may be incident earlier than a specific threshold time, and light incident beyond the specific threshold time may be the second light. This is because light reflected from the reflector 510 does not pass through the window 350 and reaches the light receiver 200 more quickly. Because the processor 400 may utilize light direction information of the light output from the light transmitter 100, the processor 400 may detect whether the incident first light is reflected by either of the first reflector 511 located above the window 350 or the second reflector 512 located below the window 350. For example, when the light is reflected by the first reflector 511, a feedback may be sent to the light transmitter 100, and the light transmitter 100 may correct a wavelength of a laser based on the feedback. A driving signal may be applied to the resonator R of the light transmitter 100, and accordingly, an initial wavelength of light may be varied. The direction of a beam steering in the vertical direction may be corrected according to the changed wavelength of light. When light with a corrected steering direction is reflected again by the first reflector 511, the steering direction may be re-corrected by using a driving signal less than the above first wavelength change or by correction (drive signal control) as a correction reference through feedback. This correction process may continue until the intensity of the first light is below a certain reference intensity or is not detected.

Next, the LiDAR device 10 according to the types of optical elements will be described.

Referring to FIGS. 2A, 2B, and 3, the optical element may include at least one reflector 510, and the at least one reflector 510 may be configured to reflect the first light toward the light receiver 200. The at least one reflector 510 may include the first reflector 511 arranged on a portion of the housing 300 above the window 350, and the second reflector 512 arranged on a portion of the housing 300 under the window 350. The first reflector 511 may be configured so that a portion of light incident on the first reflector 511 is reflected toward the light receiver 200 of the LiDAR device 10, and the second reflector 512 may be configured so that a portion of light incident on the second reflector 512 is reflected toward the light receiver 200 of the LiDAR device 10. For example, the first reflector 511 or the second reflector 512 may include a flat mirror as shown in FIGS. 2A and 2B or a diffuse reflector 513 as shown in FIG. 3. A partial surface of the first reflector 511 may be inclined at a predetermined angle with respect to the housing 300 so that the first light incident on the first reflector 511 is reflected toward the light receiver 200. A partial surface of the second reflector 512 may be inclined at a predetermined angle with respect to the housing 300 so that the first light incident on the second reflector 512 is reflected toward the light receiver 200.

When the reflector 510 is a flat mirror, the flat mirror may be arranged to be inclined at a predetermined angle with respect to the housing 300 so that the first light among light output from the light transmitter 100 is reflected toward the light receiver 200. Referring to FIG. 3, when the reflector 510 as an optical element is the diffuse reflector 513, the diffuse reflector 513 may include a partial surface that allows the light output from the light transmitter 100 to be reflected toward the light receiver 200. However, embodiments are not limited thereto, and even if the diffuse reflector 513 does not include the above-described partial surface, light diffusively reflected by the diffuse reflector 513 may be incident on the light receiver 200 by re-reflecting inside of the housing 300. Because the first light reflected from the reflector 510 will be incident on the light receiver 200 earlier than the second light reflected from the object OBJ located outside the housing 300, the first light may be distinguished based on a detection time at which the light is detected by the light receiver 200.

Referring to FIG. 2A, light output from the light transmitter 100 may be reflected by the first reflector 511 which is a flat mirror and detected by the light receiver 200. The processor 400 may detect that the light detected by the light receiver 200 is reflected by the reflector 510 by using a TOF method, or when a time during which the light is detected after the light is output from the light receiver 200 is less than a specific threshold time, the processor 400 may detect that the light is reflected by the reflector 510 of the housing 300. When the processor 400 determines that the first light is detected by the light receiver 200, the processor 400 may apply a driving signal for correcting a light steering direction to the light transmitter 100. The driving signal is applied to the resonator R included in the light transmitter 100, and accordingly, a wavelength of light entering the beam steering element BSE may be varied. When light having a varied wavelength is steered by the beam steering element BSE, the light may be steered in a direction different from the steering direction of light having a wavelength before varying. Referring to FIG. 2B, after correcting the steering direction of the light having the increased wavelength after the change, the light may be directed to the outside through the window 350 without being incident on the housing 300.

Referring to FIG. 3, each of the first reflector 511 and the second reflector 512 may be the diffuse reflector 513. Light output from the light transmitter 100 may be diffusely reflected by the second reflector 512 and detected by the light receiver 200. The second reflector 512, which is the diffuse reflector 513, may include a partial surface with a predetermined angle so that the first light incident on the second reflector 512 is reflected toward the light receiver 200. Because the steering of beam correction is the same as that described with reference to FIGS. 2A and 2B, the description thereof will be omitted.

FIG. 4A is a conceptual diagram illustrating a LiDAR device 20 including a photodetector 520 as an optical element, FIG. 4B is a block diagram illustrating signal processing performed by the LiDAR device 20 according to an example embodiment, FIG. 5A is a cross-sectional view of the LiDAR device 20 of FIG. 4A, and FIG. 5B is a cross-sectional view of the LiDAR device 20 showing a direction of light after beam steering correction.

The optical element of the LiDAR device 20 according to an example embodiment may include the photodetector 520. The photodetector 520 may be arranged adjacent to the window 350, and may be arranged along a circumference of the housing 300. To correct a beam steering in a vertical direction, the photodetector 520 may include a first photodetector 521 arranged on the housing 300 located above the window 350 and a second photodetector 522 arranged on the housing 300 located below the window 350. The photodetector 520 may be configured to measure a moving time of light similar to the light receiver 200 of the LiDAR device 20, but is not limited thereto, and the photodetector 520 may configured to measure light of a certain intensity or greater based on various methods.

Referring to FIGS. 4A, 5A, and 5B, light output from the light transmitter 100 may be detected by the photodetector 520. The processor 400 may be electrically connected to the first photodetector 521 and the second photodetector 522. When it is detected that the first light is incident on the first photodetector 521 or the second photodetector 522, the processor 400 may apply a driving signal for correcting a light steering direction to the light transmitter 100. The driving signal is applied to the resonator R included in the light transmitter 100, and accordingly, the wavelength of the light entering the beam steering element BSE may be varied. When light having a varied wavelength is steered by the beam steering element BSE, the light may be steered in a direction different from the steering direction of light having a wavelength that is not varied.

A direction in which the light is shifted in FIG. 5A and a direction in which the light is shifted in FIG. 2A are opposite to each other. When the resonator R includes the first ring resonator RR1 and the second ring resonator RR2, the driving signal in FIGS. 5A and 2A may be applied to different ring resonators, respectively. When a driving signal is applied to the first ring resonator RR1, a steering variable direction of output light may be opposite to the steering variable direction of the output light when a driving signal is applied to the second ring resonator RR2. Referring to FIG. 5B, a steering direction of light having a reduced wavelength after steering is corrected, and thus, the light may exit through the window 350 without being incident on the housing 300 or the optical element arranged on the housing 300.

The optical element of the LiDAR device according to the example embodiment is not limited to the above example. For example, the optical element may include a reflector 510 and a photodetector 520. For example, the reflector 510 may be a beam splitter configured to reflect only 50% of incident light, and the reflected light may be detected by the light receiver 200, and the remaining transmitted light may be detected by the photodetector 520. When light is detected by both the light receiver 200 and the photodetector 520, the processor 400 may provide a feedback for correcting a light steering direction to the light transmitter 100. In this way, when the optical element includes elements that serve different roles, the possibility of confusion or malfunction due to light or signals of other unknown factors may be reduced.

A difference in the resonator R may occur due to manufacturing dispersion, and thus, an initial wavelength of light output from the light transmitter 100 and the steering direction of the light may be different. The LiDAR device according to an example embodiment may detect the light that does not exit through the window 350 by using an optical element and correct a steering direction error caused by the manufacturing dispersion. As a result, light having a predetermined viewing angle may exit the window 350, and accordingly, the LiDAR device may provide a uniform performance.

FIG. 6 is a conceptual diagram of a LiDAR device 30 according to an example embodiment, and FIG. 7 is a cross-sectional view of the LiDAR device 30 of FIG. 6.

The LiDAR device 30 of FIG. 6 may include: a housing 300 including a window 350 having a light-transmitting property, a light transmitter 100 arranged in the housing 300 and configured to output light toward an object OBJ outside the housing 300, a light receiver 200 arranged in the housing 300 and including a light detection array 210 having a first region 211 configured to detect first light reflected or scattered from the housing 300 and a second region 212 configured to detect second light reflected from the object OBJ, and a processor 400 configured to adjust a steering direction of light so that a ratio of the first light to the light is reduced. The LiDAR device 30 according to an example embodiment includes the first region 211 where only the first light may be detected, and thus, when light is detected in the first region 211, the LiDAR device 30 may correct the steering direction of the light.

The light transmitter 100 of the LiDAR device 30 according to an example embodiment may include a light source S and a beam steering element BSE configured to steer light output from the light source S. In addition, the light transmitter 100 of the LiDAR device 30 according to an example embodiment may further include a resonator R arranged at both ends of the light source S and configured to change a wavelength of light. Other descriptions of the optical transmitter 100 may be the same as those described above, and thus will be omitted.

The light receiver 200 of the LiDAR device 30 according to an example embodiment may detect light reflected by an object OBJ. Only a portion of light output through the light transmitter 100 may be reflected from the object OBJ, and the reflected light may be incident on the light receiver 200. The light receiver 200 may include a plurality of detection elements DE, and the plurality of detection elements DE may constitute the light detection array 210. Among light output from the light transmitter 100, light reflected or scattered by the housing 300 may be incident on the light receiver 200.

The light receiver 200 of the LiDAR device 30 according to an example embodiment includes the light detection array 210, and the light detection array 210 includes the first region 211 and the second region 212. The first region 211 may detect the first light reflected or scattered by the housing 300, and the second region 212 may detect the second light reflected from the object OBJ. The light detection array 210 may include a plurality of detection elements DE, and some of the plurality of detection elements DE may be arranged in the first region 211, and the remaining portions may be arranged in the second region 212. The second region 212 may be arranged to be surrounded by the first region 211. For example, the first region 211 may be arranged at the top and bottom of the second region 212, and accordingly, the first region 211 may be arranged to surround the second region 212 with the second region 212 therebetween. According to another example embodiment, the first region 211 may be arranged to surround the second region 212 so as to surround the entire circumference of the second region 212. However, the arrangement of the first region 211 and the second region 212 is not limited thereto. The first region 211 may include at least one row or at least one column of an array structure.

The second region 212 of the light detection array 210 may be a region onto which light reflected from an external object OBJ is incident. A range of the second region 212 in the light detection array 210 may be determined in consideration of an angle at which light exiting through the window 350 is reflected from the object OBJ and is incident on the window 350 again. The first region 211 of the light detection array 210 may be a region in which light that is not directed to the outside, but has an interaction, such as reflected or scattered by the housing 300 is incident. The first region 211 may be arranged at a relatively edge region in the light detection array 210. The first region 211 and the second region 212 may not overlap, and a range of the first region 211 and a range of the second region 212 may be appropriately changed. When light is detected in the second region 212 of the light detection array 210 of the light receiver 200, the processor 400 may apply a driving signal for correcting a steering direction of the light to the light transmitter 100. The details of the correction of the steering direction of light have been described above, and thus will be omitted.

The LiDAR device 30 according to FIGS. 6 and 7 may further include an optical element that is arranged adjacent to the window 350 on the housing 300 and through which the first light among light is incident. For example, a reflector 510 (FIG. 1A) may be used as the optical element, and the reflector 510 may be configured and arranged to reflect light incident on the reflector 510 toward the first region 211 of the array structure.

FIG. 8 is a flowchart of a beam steering correction method according to an example embodiment.

Referring to FIG. 8, the beam steering correction method according to an example embodiment includes outputting light from the light transmitter 100 of the LiDAR devices 10, 20, or 30 (S101), detecting first light incident on the housing 300 of the LiDAR devices 10, 20, and 30 (S102), applying a driving signal to the resonator R included in the light receiver 200 by the processor 400 of the LiDAR devices 10, 20, and 30 so that the light is not incident on the housing 300 when the first light is detected (S103), and varying a wavelength of light and correcting a steering direction of the light by the application of the driving signal (S104).

Light is output from the light transmitter 100 of the LiDAR devices 10, 20, and 30 (S101). Light output from the light source S, the resonator R, and the optical phased array of the light transmitter 100 is steered in a vertical direction and may have a predetermined field of view (FOV). The steered light may be directed outward through the window 350 of the housing 300. Some of the light may not pass through the window 350 due to the steered angle and may be incident on the housing 300. An optical element may be included in the housing 300 to detect the first light incident on the housing 300 of the LiDAR devices 10 and 20, and the optical element may be configured to directly detect the first light or to reflect the first light in a direction towards the light receiver 200. The optical element configured to reflect light in the direction of the light receiver 200 may include at least one reflector 510, and the LiDAR device may be the LiDAR device 10 according to an example embodiment described with reference to FIGS. 1A to 3. The optical element may include at least one photodetector 520 to directly detect light, and the LiDAR device may be the LiDAR device 20 according to an example embodiment described with reference to FIGS. 4A to 5B. According to another example embodiment, instead of the LiDAR devices 10 and 20 including the optical element, the light receiver 200 of the LiDAR device 30 may include a light detection array 210 having a first region 211 configured to detect first light reflected or scattered from the housing 300 and a second region 212 configured to detect second light reflected from an object OBJ. The light receiver 200 including the light detection array 210 having the first region 211 and the second region 212 may be the LiDAR device 30 according to an example embodiment described with reference to FIGS. 6 and 7. While the light receiver 200 of the LiDAR device 30 includes the light detection array 210, the LiDAR device 30 may further include an optical element.

The first light incident on the housing 300 of the LiDAR devices 10, 20, and 30 is detected (S102). When the optical element is the reflector 510, the first light incident on and reflected from the reflector 510 on the housing 300 of the LiDAR device 10 may be detected by the light receiver 200. When the optical element is the photodetector 520, the first light incident on the housing 300 may be detected directly by the photodetector 520. However, embodiments are not limited thereto, and in the case of other optical elements, light incident on the housing 300 may be detected through other methods.

When the first light is detected, the processor 400 of the LiDAR devices 10, 20, and 30 may adjust a driving signal to be applied to the resonator R included in the optical transmitter 100 so that light may not incident on the housing 300 (S103). Among a plurality of ring resonators RR1 and RR2 included in the resonator R, the ring resonator to which the driving signal is applied may be determined depending on whether the first light is incident on the housing 300 located above the window 350 or the first light is incident on the housing 300 located below the window 350. Also, the magnitude of the driving signal may be determined according to the intensity of the first light or a ratio of the first light to the light emitted from the light transmitter 100.

A wavelength of the light may be changed by the application of the driving signal, and the steering direction of the light may be corrected (S104). When light is steered by the beam steering element BSE, the steering direction may be changed according to the wavelength of the light. A bandwidth of light that is amplified by the resonator R by receiving a driving signal may vary, and a wavelength of the light input to the beam steering element BSE may also vary. Because the wavelength of the light is varied, a direction in which the light is steered in the beam steering element BSE may be varied or corrected.

FIG. 9 is a block diagram illustrating a configuration of an electronic device 2201 including the LiDAR devices 10, 20, and 30 according to an example embodiment.

Referring to FIG. 9, in a network environment, the electronic device 2201 may communicate with another electronic device 2202 through a first network 2298 (a short-range wireless communication network, etc.) or communicate with another electronic device 2204 and/or a server 2208 through a second network 2299 (a long-distance wireless communication network, etc.). The electronic device 2201 may communicate with another electronic device 2204 through the server 2208. The electronic device 2201 may include a processor 2220, a memory 2230, an input device 2250, an audio output device 2255, a display device 2260, an audio module 2270, a sensor module 2210, an interface 2277, a haptic module 2279, a camera module 2280, a power management module 2288, a battery 2289, a communication module 2290, a subscriber identification module 2296, and/or an antenna module 2297. In the electronic device 2201, some of these components (e.g., the display device 2260) may be omitted or other components may be added. Some of these components may be implemented as one integrated circuit. For example, a fingerprint sensor 2211, an iris sensor, or an illuminance sensor, etc. of the sensor module 2210 may be implemented by being embedded in the display device 2260 (display, etc.).

The processor 2220 may control one or a plurality of other components (hardware, software components, etc.) of the electronic device 2201 connected to the processor 2220 by executing software (a program 2240, etc.), and perform various data processing or operations. As a part of data processing or operation, the processor 2220 may load commands and/or data received from other components (the sensor module 2210, the communication module 2290, etc.) into a volatile memory 2232, process commands and/or data stored in the volatile memory 2232, and store resulting data in a non-volatile memory 2234. The processor 2220 may include a main processor 2221 (central processing unit, application processor, etc.) and an auxiliary processor 2223 (graphic processing unit, image signal processor, sensor hub processor, communication processor, etc.) that may be independently operated or operated together with the main processor 2221. The auxiliary processor 2223 may use less power than the main processor 2221 and may perform a specialized function.

The auxiliary processor 2223 may control functions and/or states related to some of the components (the display device 2260, the sensor module 2210, the communication module 2290, etc.) of the electronic device 2201 in place of the main processor 2221 while the main processor 2221 is in an inactive state (sleep state) or together with the main processor 2221 while the main processor 2221 is in an active state (the application execution state). The auxiliary processor 2223 (image signal processor, communication processor, etc.) may be implemented as a part of other functionally related components (camera module 2280, communication module 2290, etc.).

The memory 2230 may store various data required by the components (the processor 2220, the sensor module 2276, etc.) of the electronic device 2201. The data may include, for example, software (program 2240, etc.) and input data and/or output data for commands related to the software. The memory 2230 may include a volatile memory 2232 and/or a non-volatile memory 2234.

The program 2240 may be stored as software in the memory 2230, and may include an operating system 2242, middleware 2244, and/or an application 2246.

The input device 2250 may receive a command and/or data to be used by the components (the processor 2220, etc.) of the electronic device 2201 from an external (a user, etc.) of the electronic device 2201. The input device 2250 may include a microphone, a mouse, a keyboard, and/or a digital pen (a stylus pen, etc.).

The sound output device 2255 may output a sound signal to the outside of the electronic device 2201. The sound output device 2255 may include a speaker and/or a receiver. The speaker may be used for general purposes, such as multimedia playback or recording playback, and the receiver may be used to receive incoming calls. The receiver may be integrated as a part of the speaker or may be implemented as an independent device.

The display device 2260 may visually provide information to the outside of the electronic device 2201. The display device 2260 may include a display, a hologram device, or a projector and a control circuit for controlling a corresponding device. The display device 2260 may include a touch circuitry configured to sense a touch, and/or a sensor circuitry (a pressure sensor, etc.) configured to measure the intensity of a force generated by the touch.

The audio module 2270 may convert a sound into an electrical signal or, conversely, convert an electrical signal into a sound. The audio module 2270 may obtain a sound through the input device 2250 or may output a sound through a speaker and/or a headphone of other electronic device (the electronic device 2102, etc.) directly or wirelessly connected to the sound output device 2255 and/or the electronic device 2201.

The sensor module 2210 may detect an operating state (power, temperature, etc.) of the electronic device 2201 or a state of an external environment (user state, etc.), and may generate an electrical signal and/or data value corresponding to the sensed state. The sensor module 2210 may include a fingerprint sensor 2211, an acceleration sensor 2212, a position sensor 2213, a 3D sensor 2214, and the like, and in addition to these sensors, may include an iris sensor, a gyro sensor, a barometric pressure sensor, and a magnetic sensor, a grip sensor, a proximity sensor, a color sensor, an infrared (IR) sensor, a biometric sensor, a temperature sensor, a humidity sensor, and/or an illuminance sensor.

The 3D sensor 2214 irradiates predetermined light to an object and analyzes light reflected from the object to sense a shape and movement of the object, and the LiDAR devices 10, 20, and 30 described with reference to FIGS. 1A to 7 may be employed as the 3D sensor 2214. When there is an object in a target area and light reflected therefrom is detected, a digital scan of the target area may be started and information on the object may be analyzed.

The interface 2277 may support one or more designated protocols that may be used by the electronic device 2201 to connect directly or wirelessly with another electronic device (the electronic device 2102, etc.). The interface 2277 may include a high definition multimedia interface (HDMI), a universal serial bus (USB) interface, an SD card interface, and/or an audio interface.

The connection terminal 2278 may include a connector through which the electronic device 2201 may be physically connected to another electronic device (the electronic device 2202, etc.). The connection terminal 2278 may include an HDMI connector, a USB connector, an SD card connector, and/or an audio connector (a headphone connector, etc.).

The haptic module 2279 may convert an electrical signal into a mechanical stimulus (vibration, movement, etc.) or an electrical stimulus that a user may perceive through tactile or kinesthetic sense. The haptic module 2279 may include a motor, a piezoelectric element, and/or an electrical stimulation device.

The camera module 2280 may capture still images and moving images. The camera module 2280 may include a lens assembly including one or more lenses, image sensors, image signal processors, and/or flashes. The lens assembly included in the camera module 2280 may collect light emitted from an object, which is an object to be imaged, and the LiDAR devices 10, 20, and 30 described with reference to FIGS. 1A to 7 may be included in the lens assembly.

The power management module 2288 may manage power supplied to the electronic device 2201. The power management module 388 may be implemented as a part of a Power Management Integrated Circuit (PMIC).

The battery 2289 may supply power to components of the electronic device 2201. The battery 2289 may include a non-rechargeable primary cell, a rechargeable secondary cell, and/or a fuel cell.

The communication module 2290 may establish a direct (wired) communication channel and/or wireless communication channel between the electronic device 2201 and other electronic devices (electronic device 2202, electronic device 2204, server 2208, etc.); and may support the communication performance through the established communication channel. The communication module 2290 may include one or more communication processors that are operated independently from the processor 2220 (an application processor, etc.) and may support direct communication and/or wireless communication. The communication module 2290 may include a wireless communication module 2292 (a cellular communication module, a short-range wireless communication module, a global navigation satellite system (GNSS) communication module, etc.) and/or a wired communication module 2294 (a local area network (LAN) communication module, a power line communication module, etc.). Among these communication modules, a corresponding communication module may communicate with other electronic devices through the first network 2298 (a short-range communication network, such as Bluetooth, WiFi Direct, or Infrared Data Association (IrDA)) or the second network 2299 (a telecommunication network, such as a cellular network, the Internet, or a computer network (LAN, WAN, etc.). These various types of communication modules may be integrated into one component (single chip, etc.) or implemented as a plurality of components (plural chips) separate from each other. The wireless communication module 2292 may identify and authenticate the electronic device 2201 by using subscriber information (International Mobile Subscriber Identifier (IMSI), etc.) stored in the subscriber identification module 2296 within a communication network, such as the first network 2298 and/or the second network 2299.

The antenna module 2297 may transmit or receive signals and/or power to and from the outside (other electronic devices, etc.). The antenna may include a radiator having a conductive pattern formed on a substrate (a PCB, etc.). The antenna module 2297 may include one or a plurality of antennas. When a plurality of antennas are included, an antenna suitable for a communication method used in a communication network, such as the first network 2298 and/or the second network 2299 may be selected from among the plurality of antennas by the communication module 2290. Signals and/or power may be transmitted or received between the communication module 2290 and another electronic device through the selected antenna. In addition to the antenna, other components (an RFIC, etc.) may be included as a part of the antenna module 2297.

Some of the components are connected to each other through communication methods between peripheral devices (bus, general purpose input and output (GPIO), serial peripheral interface (SPI), mobile industry processor interface (MIPI), etc.) and signals (commands, data, etc.) are interchangeable.

Commands or data may be transmitted or received between the electronic device 2201 and the external electronic device 2204 through the server 2208 connected to the second network 2299. The other electronic devices 2202 and 2204 may be the same type as or different type from that of the electronic device 2201. All or part of operations executed in the electronic device 2201 may be executed in one or more of the other electronic devices 2202 and 2204 and the server 2208. For example, when the electronic device 2201 needs to perform a function or service, the electronic device 2201 may request one or more other electronic devices to perform part or all of the function or service instead of executing the function or service itself. One or more other electronic devices receiving the request may execute an additional function or service related to the request, and transmit a result of the execution to the electronic device 2201. For this purpose, cloud computing, distributed computing, and/or client-server computing technologies may be used.

FIG. 10 is a perspective view showing an electronic device to which one of the LiDAR devices 10, 20, and 30 according to an example embodiment is applied.

Although FIG. 10 is illustrated in the form of a mobile phone or a smart phone 3000, the electronic device to which one of the LiDAR devices 10, 20, and 30 is applied is not limited thereto. For example, the LiDAR devices 10, 20, and 30 may be applied to a tablet or a smart tablet, a notebook computer, a television or a smart television, etc.

In addition, the LiDAR devices 10, 20, and 30 according to an example embodiment may be applied to an autonomous driving device.

FIGS. 11 and 12 are respectively a side view and a plan view of a vehicle 4000 including one of the LiDAR devices 10, 20, and 30 according to an example embodiment.

Referring to FIG. 11, a LiDAR device 1001 may be applied to the vehicle 4000, and information on an object 60 may be obtained by using the LiDAR device 1001. The LiDAR devices 10, 20, and 30 described with reference to FIGS. 1A to 7 may be employed as the LiDAR device 1001. The LiDAR device 1001 may use a time-of-flight (TOF) method to obtain information about the object 60. The vehicle 4000 may be a vehicle having an autonomous driving function. When there is an object in a target area and light reflected therefrom is detected, a digital scan of the target area may be started, and information on the object may be analyzed. By using the LiDAR device 1001, an object or person in a direction in which the vehicle 4000 is traveling, that is, the object 60 may be detected, and a distance to the object 60 may be measured by using information, such as a time difference between a transmission signal and a detection signal. In addition, as shown in FIG. 12, information on a near object 61 and a far object 62 within the target area TF may be acquired.

FIGS. 11 and 12 illustrate that a LiDAR device is applied to a vehicle, but is not limited thereto. A LiDAR device may be applied to a flying object, such as drones, mobile devices, small walking means (e.g., bicycles, motorcycles, strollers, boards, etc.), robots, and auxiliary means of humans/animals (e.g., canes, helmets, ornaments, clothing, watches, bags, etc.), Internet of Things (IoT) devices/systems, security devices/systems, and the like.

Although the above-described LiDAR device and electronic device have been described with reference to the example embodiment shown in the drawings, it will be understood by those skilled in the art that various changes in form and details may be made therein without departing from the spirit and scope.

Therefore, the example embodiments should be considered in descriptive sense only and not for purposes of limitation.

The scope of embodiments are defined not by the detailed description but by the appended claims, and all differences within the scope will be construed as being included.

The LiDAR device according to an example embodiment may correct a steering direction of light when the light is deviated from an expected steering direction. The LiDAR device according to an example embodiment may allow light of a predetermined viewing angle to pass through a window, and may implement accurate object measurement. The LiDAR device according to an example embodiment may be utilized in various electronic devices and autonomous driving devices.

It should be understood that example embodiments described herein should be considered in a descriptive sense only and not for purposes of limitation.

Descriptions of features or aspects within each example embodiment should typically be considered as available for other similar features or aspects in other embodiments.

While example embodiments have been described with reference to the figures, it will be understood by those of ordinary skill in the art that various changes in form and details may be made therein without departing from the spirit and scope as defined by the following claims and their equivalents.

What is claimed is:

1. A light detection and ranging (LiDAR) device comprising:
a housing comprising a window;
a light transmitter provided in the housing and configured to output light toward an object outside of the housing;
an optical element provided adjacent to the window and on which first light from among the light transmitted by the light transmitter is incident;
a light receiver provided in the housing and configured to receive, second light reflected from the object, from among the light transmitted by the light transmitter; and
a processor configured to change a steering direction of the light so that a ratio of the first light to the light transmitted by the light transmitter is reduced.

2. The LiDAR device of claim 1, wherein the light transmitter comprises:
a light source; and
a beam steering element configured to steer the light output from the light source toward the object.

3. The LiDAR device of claim 2, wherein the beam steering element comprises an optical phase configured to steer the light so that a steering direction of the light is changed based on a wavelength of the light.

4. The LiDAR device of claim 2, wherein the light transmitter further comprises a resonator provided at both ends of the light source and configured to change a wavelength of the light.

5. The LiDAR device of claim 4, wherein the resonator comprises a first ring resonator having a first circumference and a second ring resonator having a second circumference that is less than the first circumference,
wherein the first ring resonator is configured to, based on a driving signal applied to the first ring resonator, increase the wavelength of the light, and
wherein the second ring resonator is configured to, based on a driving signal applied to the second ring resonator, decrease the wavelength of the light.

6. The LiDAR device of claim 5, wherein the processor is further configured to, based on the first light being detected by the optical element or the light receiver, apply a driving signal to one of the first ring resonator and the second ring resonator to change the steering direction of the light.

7. The LiDAR device of claim 1, wherein the optical element comprises at least one reflector configured to reflect the first light toward the light receiver, and
wherein the light receiver is configured to receive the first light.

8. The LiDAR device of claim 7, wherein the at least one reflector comprises at least one of a flat mirror and a diffuse reflector.

9. The LiDAR device of claim 7, wherein a partial surface of the at least one reflector is inclined at a predetermined angle with respect to the housing so that the first light that is incident is reflected toward the light receiver.

10. The LiDAR device of claim 1, wherein the optical element comprises at least one photodetector configured to detect the first light that is incident.

11. The LiDAR device of claim 1, wherein an area of the window is greater than or equal to an area of the housing which is irradiated by the light steered by the light transmitter.

12. The LiDAR device of claim 1, wherein the optical element comprises a first optical element provided above the window and a second optical element provided below the window.

13. A light detection and ranging (LiDAR) device comprising:
a housing comprising a window;
a light transmitter provided in the housing and configured to output light toward an object outside of the housing;
a light receiver provided in the housing and comprising a light detection array, the light detection array comprising:
a first region configured to detect first light reflected or scattered from the housing among the light transmitted by the light transmitter; and
a second region configured to detect second light reflected from the object among the light transmitted by the light transmitter; and
a processor configured to change a steering direction of the light such that a ratio of the first light to the light transmitted by the light transmitter is reduced.

14. The LiDAR device of claim 13, wherein the light detection array comprises a plurality of detection elements, and
wherein the first region and the second region do not overlap each other.

15. The LiDAR device of claim 13, wherein the light transmitter comprises:
a light source;
a beam steering element configured to steer the light output from the light source; and
a resonator provided at both ends of the light source and configured to change a wavelength of the light.

16. The LiDAR device of claim 15, wherein the beam steering element comprises an optical phase array configured to steer the light so that the steering direction of the light is changed based on the wavelength of the light.

17. The LiDAR device of claim 15, wherein the resonator comprises a first ring resonator having a first circumference and a second ring resonator having a second circumference that is less than the first circumference, wherein the first ring resonator is configured to, based on a driving signal applied to the first ring resonator, increase the wavelength of the light, and
wherein the second ring resonator is configured to, based on a driving signal applied to the second ring resonator, decrease the wavelength of the light.

18. The LiDAR device of claim 15, wherein the processor is further configured to apply a driving signal to the resonator based on the first light being detected in the first region.

19. The LiDAR device of claim 13, wherein the second region is at least partially adjacent to the first region.

20. The LiDAR device of claim 13, further comprising an optical element provided adjacent to the window,
wherein the first light from among the light is incident on the optical element.
